(19) United States
(12) Patent Application Publication
(10) Pub. No.: US 2021/0162777 A1
(43) Pub. Date: Jun. 3, 2021

(54) COMPARISONS OF TEMPERATURES ON CONVEYING COMPONENTS OF MEDIA CONDITIONERS

(71) Applicant: Hewlett-Packard Development Company, L.P., Spring, TX (US)

(72) Inventors: Robert Yraceburu, Vancouver, WA (US); Daniel James Magnusson, Vancouver, WA (US); Vladislav Shapoval, Vancouver, WA (US)

(21) Appl. No.: 17/047,980

(22) PCT Filed: Jul. 13, 2018
(86) PCT No.: PCT/US2018/042156

§ 371 Date: Oct. 15, 2020

(51) Int. Cl. B41J 11/00; F26B 3/20

(52) U.S. Cl. CPC B41J 11/002; F26B 3/20

(57) ABSTRACT

In some examples, a media conditioner includes a heated conveying component to convey a sheet of printable media, the conveying component including a first portion extending widthwise, and a second portion extending widthwise from the first portion. The media conditioner also includes a first temperature sensor to measure temperature of the first portion of the conveying component; a second temperature sensor to measure temperature of the second portion of the conveying component; and a controller to produce a determination involving a first temperature at the first portion of the conveying component, a second temperature at the second portion of the conveying component, a reference temperature of the first portion, and a reference temperature of the second portion, and a threshold value. The controller is to produce a result indicator based on the comparison

### BACKGROUND

Printing images or text on printable media in a printer includes various media processing activities, including pick-up, delivery to a print engine, printing, and conditioning of sheets of printable media. Conditioning involves heating and pressing the sheets through or past a heated pressure roller (HPR) to remove liquid (for printers using liquid ink), to remove wrinkles or curvature, or to reform or flatten fibers in the sheets.

### BRIEF DESCRIPTION OF THE DRAWINGS

Various examples are described below referring to the following figures:

FIG. 1 shows a media printing system, which includes a media conditioner in accordance with various examples;

FIG. 2 shows a partially schematic view of the media conditioner of FIG. 1, which includes heat lamps, a heated belt, and a controller in accordance with various examples;

FIG. 3 shows a bottom view of the heat lamps and a heated belt of FIG. 2 in accordance with various examples;

FIG. 4 shows a schematic view of the media conditioner of FIG. 2 in accordance with various examples;

FIG. 5 shows a flow diagram of a method of operating the media conditioner of FIG. 2 in accordance with various examples; and

FIG. 6 shows a flow diagram of a method of operating the media conditioner of FIG. 2 in accordance with various examples.

### DETAILED DESCRIPTION

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the following discussion and in the claims, the terms “including” and “comprising” are used in an open-ended fashion, and thus should be interpreted to mean “including, but not limited to . . . ” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally refer to positions along or parallel to a central or longitudinal axis (e.g., a central axis of a body or a port). As used herein, including in the claims, the word “or” is used in an inclusive manner. For example, “A or B” means any of the following: “A” alone, “B” alone, or both “A” and “B.”

In various examples, a media printing system includes a media conditioner coupled to a printer apparatus, which may also be called a print engine. The print engine is capable of forming an image on a sheet of printable media by a technology such as inkjet, laser, or digital offset, as examples. The media conditioner is positioned to receive sequentially sheets of printed media from the printing device after images are formed on the sheets. The images may include text, figures, or photographic images and may be black, monochrome, or multi-color, as examples. In various examples, conditioning the media includes heating the media, removing an ink solvent, melting an ink, or improving the flatness of the media. In various examples, the media printing system may also be called a printer, an all-in-one printer, or a photocopier. The media conditioner includes a conveying component to conductively heat and move a sheet of printable media and a first heating element and a second heating element to heat the conveying component. The conveying component may be a roller or a belt, as examples. In an example, the first conveying component is a belt, and the media conditioner includes a first heating element to heat an inner portion of the width of the belt, a first temperature sensor positioned to measure the inner portion, a second heating element to heat the outer portion of the width of the belt, which includes the two sides of the belt, a second temperature sensor positioned to measure the outer portion, and a controller to provide separate power levels to the heating elements based on measurements from the temperature sensors While active, the controller is to maintain the belt at a temperature set-point.

During operation, the controller is to make a determination based on recently measured values of operating temperatures from the first and second sensors, in view of set-point values or other anticipated values. A large difference between the measured and the anticipated temperatures or temperature differences may indicate a hardware or firmware issue needs attention. The determination may occur during various stages of operation, such as a heat-up, a cool-down, or steady state.

In addition, the controller may include functionality to compare the power levels of the heaters, or another set of parameters associated with the power levels, to evaluate the performance of the media conditioner, which may be helpful, for example, while the first and second sensors provide results that are or that appear acceptable. For example, the controller may calculate a running average of the power level that is provided to the first heating element over a time period and to calculate a running average of the separate power level that is provided to the second heating element over the same time period. The controller is to calculate an arithmetic difference between these two power levels and to compare that difference against a predetermined threshold value for the power levels. The controller is to perform a task if the difference is greater than the threshold value. The task may include, as examples, refusing to accept printable media, shutting-down, or sending a notification. In some examples, arithmetic differences are calculated for each reading of the two power levels, and the multiple values of these power level differences are then averaged and evaluated against the threshold value. In a scenario in which both temperature sensors are fully functional, but a temperature sensor is misaligned, a comparison of readings from the temperature sensors might not reveal the misalignment. In some examples, evaluating the relative power levels of the heaters, as described, could indicate that a heating issue may merit attention. Examples of media conditioners for media printing systems and techniques of evaluating them are described below.

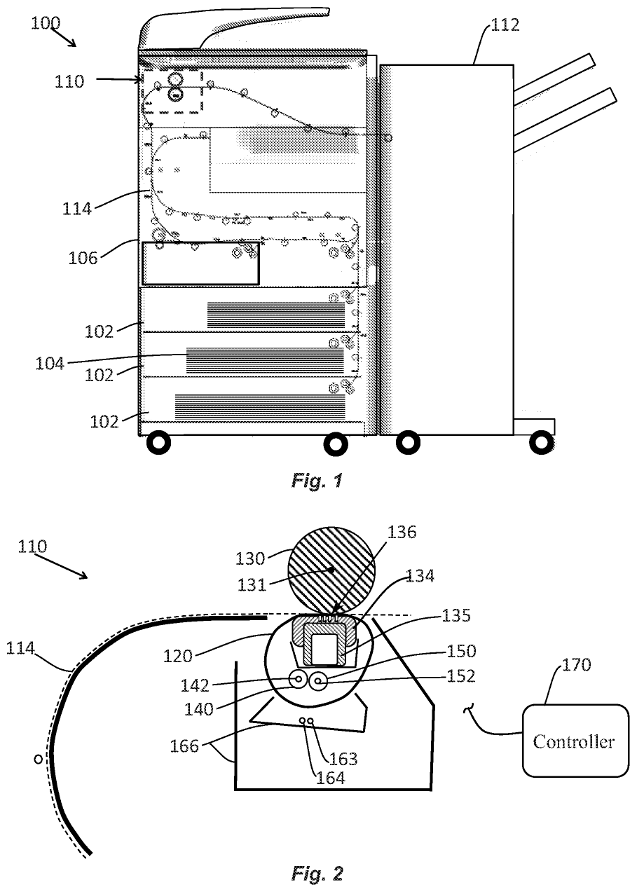

The example of FIG. 1 shows a media printing system 100 that includes multiple media trays 102 to hold multiple sheets of printable media 104, a print engine 106, a media conditioner 110, and a finisher 112. A media path 114 extends from media trays 102 to print engine 106, media conditioner 110, and finisher 112. In the separate media trays 102, the sheets of printable media may vary by face size, thickness, paper type, color, etc.

Referring now to FIG. 1 and FIG. 2, media conditioner 110 includes a first conveying component coupled to engage a second conveying component to receive, contact, heat, and convey a sheet of printable media 104. In this example, the first conveying component is a heated belt 120, and the second conveying component is a driven roller 130, which may be driven to rotate by a motor. Roller 130 extends widthwise along a central axis 131. Media conditioner 110 includes a platen 134 and a platen support structure 135 to support and guide the belt 120, a first and a second heater, a first and a second temperature sensor 163, 164, a chassis 166, and a controller 170. In this example, the heaters are radiant heaters, which include a first lamp 140 having a first heating element 142 and a second lamp 150 having a second heating element 152. Lamps 140, 150 are located within belt 120 to heat the belt by thermal radiation from the inside. During operation, roller 130 is conductively heated by contact with belt 120, and media, when present, is to be heated by contact with belt 120 and roller 130. In some examples, heating elements 142, 152 may be disposed outside belt 120. Lamps 140, 150 may be halogen-type lamps, but other types of lamps or other types of heating elements may be used in various other examples to heat belt 120 or roller 130.

Belt 120 and roller 130 contact and press against each other along a nip region 136 to receive and convey the media. Nip region 136 extends along the shared width of belt 120 and roller 130. During operation, rotational movement of the roller 130 drives the belt 120 to rotate, with or without media, in between the roller 130 and the belt 120. First and second temperature sensors 163, 164 are non-contacting thermistors located outside and below belt 120. Other examples may include another form of non-contact temperature sensor or may include a contact temperature sensor located in an appropriate position.

Some examples of a media conditioner 110 include temperature sensors to monitor the temperatures at locations along the width of the second conveying component, for example roller 130. Some examples of a media conditioner may include a conveying component, such as a belt 120 or a roller 130, that is conductively heated.

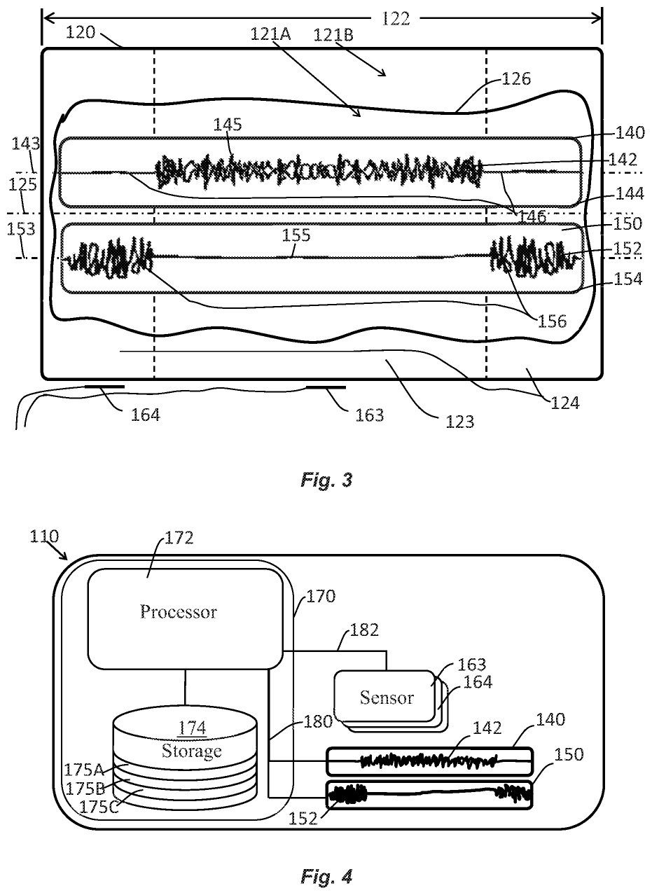

Referring now to the bottom view of FIG. 3, belt 120 is shown as if a portion were removed, creating a window 126 that exposes an interior region of the belt, making lamps 140, 150 visible. Belt 120 includes an inner surface 121A, an outer surface 121B, and a width 122, which can be considered to include a first or inner portion 123 and a second or outer portion(s) 124. Belt 120 wraps around an axis 125 that extends widthwise. Outer portion 124 includes the two sides of the belt that extend in opposite directions from inner portion 123. Thus, these “inner” and “outer” portions 123, 124 are defined along width 122 and are distinguished by vertical, dashed lines in FIG. 3. A portion or the entirety of first heating element 142 of lamp 140 and a portion or the entirety of second heating element 152 of lamp 150 extend axially within the loop formed by belt 120, extending parallel to width 122. Belt 120 is thus to travel in its loop around heating elements 142, 152.

Still referring to FIG. 3, the first lamp 140 and its first heating element 142 extend lengthwise along a longitudinal axis 143 within a tubular bulb 144, and the second lamp 150 and its second heating element 152 extend lengthwise along a longitudinal axis 153 within a tubular bulb 154. Axes 143, 153 extend parallel to axis 125 of belt 120 and axis 131 of roller 130. (Roller axis 131 is visible in FIG. 2.) When energized, a central portion 145 of first heating element 142 is active and producing heat, while the outer portion(s) 146 (e.g., beyond each end of central portion 145) produces little or negligible heat. When energized, the axially central portion 155 of second heating element 152 produces little or negligible heat; while the outer portion(s) 156 (e.g., beyond each end of central portion 155), of second heating element 152 are active, and producing heat. Thus, first heating element 142 may also be called an inner heating element, and second heating element 152 may also be called an outer heating element for width 122 of belt 120.

The central, active portion 145 of inner heating element 142 is sized and positioned to heat the belt's inner portion 123 along the belt's inner surface 121A, and the first temperature sensor 163 is positioned to measure temperature on the outer surface 121B of inner portion 123. The outer, active portion 156 of heating element 152 of lamp 150 is sized and positioned to heat the belt's outer portion 124 along the belt's inner surface 121A, and the second temperature sensor 164 is positioned to measure temperature on the outer surface 121B of outer portion 124. In some examples, inner portion 123 and the first heating element 142 extend along 60% of the belt's width 122, and outer portion 124 and second heating element 152 extend along 40% of the belt's width. A size ratio of 60:40 thus may exist for the inner and outer portions 123, 124 and between the effective heating lengths of lamps 140, 150. In some examples, the ratio is greater than 60:40, and in some examples the ratio is less than 60:40. In some examples, the ratio is greater than or equal to 50:50 and less than or equal to 90:10. Other ratios are possible.

As shown in FIG. 4, controller 170 includes a processor 172, storage 174, electrical couplings 180 for heat lamps 140, 150, and electrical couplings 182 for sensors (of which temperature sensors 163, 164 are examples). In various examples, controller 170 may be assigned to govern the operation of media printing system 100 as a whole or may be assigned to govern media conditioner 110 alone, being coupled to communicate with another controller of media printing system 100. In some examples, controller 170 shares components, such as storage 174, with another controller of media printing system 100.

Storage 174 is a computer-readable storage medium storing, for example, machine executable code to be executed by processor 172. In various examples, machine executable code may also be called machine readable instructions or computer executable code. The machine executable code stored in storage 174 includes code 175A, code 175B, and code 175C. When executed by controller 170, code 175A governs the normal heating operations of lamps 140, 150, code 175B governs a power level evaluation for lamps 140, 150, and code 175C governs a temperature level evaluation for sensors 163, 164. Code 175A, when executed by controller 170, includes instructions to cause controller 170 (e.g., its processor 172) to provide a first power level to first lamp 140 and its heating element 142 and to provide a second power level to the second lamp 150 and its heating element 152, and to cause the first and second heating elements 142, 152 to generate heat to heat the belt 120. In addition, code 175A includes instructions to cause controller 170 to monitor signals or data from sensors 163, 164 to modulate the power supplied to heating elements 142, 152 and maintain a uniform temperature or a selected temperature distribution across the width of belt 120, based on a targeted temperature set-point or set-points. The first and second power levels are variable. During operation, controller 170 is to provide separate first and second power level signals and may vary the signals to vary the first and second power levels provided to heating elements 142, 152, respectively. In an example, the power level signals are pulse-width-modulated (PWM) signals. Whether controller 170 uses a PWM signal, another analog power level signal, or a digital power level signal, the signals may vary incrementally or smoothly from zero to 100%. The value of 100% power refers to the maximum power that the heating element can accept or the maximum power that the system can provide, whichever is lower. Broadly, the term “power level” will refer to the electrical power available to a heating element or used by a heating element, or it will refer to the power level signal for controlling the electrical power to a heating element. Although electrical couplings 180 are simply shown as a direct connection between controller 170 and heating lamps 140, 150, in various examples, electrical couplings 180 connect the controller 170 to a power supply that feeds heating lamps 140, 150.

Referring again to FIG. 4, machine executable code 175C in storage 174 includes instructions that, when executed by controller 170, cause controller 170 (e.g., its processor 172) to evaluate the performance of temperature sensors 163, 164 and heating elements 142, 152. As a consequence of the performance evaluation of temperature sensors 163, 164, controller 170 is to produce a result indicator based on comparisons between the temperatures and temperature differences for belt 120. The result indicator may be, as examples, a signal from controller 170 that is initiated or a signal from controller 170 that is stopped. The result indicator may communicate a command to a component in media conditioner 110 or to a component in media printing system 100. The command may be to stop or pause functioning or to perform an action. For example, the media conditioner may stop receipt of printable media in response to the result indicator. In some examples, the result indicator includes a signal that causes print engine 106 (FIG. 1) to stop processing sheets of printable media. The result indicator may provide indication to a user. In some examples, the result indicator causes the media conditioner (e.g., controller 170) to set to zero the power level of heating element 142 or of heating element 152. In several of these examples, the controller 170 is to transmit the result indicator to a component that is external to the controller.

The following discussion will describe an example of a temperature sensor performance evaluation for belt 120 in media conditioner 110 as may be implemented by controller 170 executing code 175C. Expression 1, shown here, presents a failing condition for temperature measurements from sensors 163, 164 during the operation of media conditioner 110:

(T₁−T₂)−ΔT_{ref}<−T_{tolerance}

Or

(T₁−T₂)−ΔT_{ref}>T_{tolerance}

In Expression 1, T₁ is a temperature of the belt inner portion 123, as may be measured by sensor 163 during operation. The parameter T₂ is a temperature of the belt outer portion 124, as may be measured by sensor 164 during operation.

The value ΔT_{ref} is a reference value describing an anticipated difference in temperatures for belt inner portion 123 and outer portion 124. This reference temperature difference will be discussed below. The value T_{tolerance} is a tolerance or threshold value.

If a result of Expression 1 is true, then the difference between temperatures T₁ and T₂ is too large, which is a failing condition for the operation of media conditioner 110. Detecting whether or not media conditioner 110 has reached a failing condition is a goal of code 175C. Controller 170 is to produce the result indicator as a result of the failing condition being determined from Expression 1.

If instead a result of the following expression, Expression 2, is true, then a “passing condition” has been determined for media conditioner 110. A passing condition indicates that the temperatures for belt inner portion 123 and outer portion 124 are acceptably balanced or have an acceptable difference and indicates that power levels provided to heating elements 142, 152 are likely to be set properly. A passing condition may be expressed as:

−T_{tolerance}≤(T₁−T₂)−ΔT_{ref}≤T_{tolerance} 2

A passing condition is achieved when a comparison between the temperature difference (T₁−T₂) during operation and the reference temperature difference, ΔT_{ref}, returns a value that is equal to or less than the threshold value, T_{tolerance}. For Expressions 1 or 2 the comparison is a subtraction, but in some examples, the comparison may use a ratio between the temperature difference (T₁−T₂) and the reference temperature difference. A passing condition may be determined by Expression 2 producing a true result or by Expression 1 producing a false result. For convenience, the temperature difference (T₁−T₂) may be called a first temperature difference, the reference temperature difference (ΔT_{ref}) may be called a second temperature difference, and the subtraction of these values ((T₁−T₂)−ΔT_{ref}) may called a third temperature difference.

In various examples, as a result of a passing condition, controller 170 is to produce no result indicator equivalent to the result indicator for the true result of Expression 1, or controller 170 is to cancel a result indicator that was activated based on Expression 1. For example, in a first time period (e.g., time period Δt₀) the controller may use Expression 1 or 2 and make a determination that activates the result indicator. During a subsequent time period (e.g., time period Δt₁), the controller is to evaluate updated values of the first, second, and third temperature differences and is to make an updated determination. If the magnitude of the updated value of the third temperature difference is less than or equal to the magnitude of the threshold value, the controller is to make a determination that a passing condition exists. As a result, the controller may cease to produce the result indicator.

Considering the parameters of Expression 1 and Expression 2 in more detail, the temperatures T₁ or T₂ may be measured by temperature sensors 163, 164, respectively. Temperatures T₁ or T₂ reflect the current operating condition of lamps 140, 150 and may be called present or real-time temperature values, and the expression (T₁−T₂) may be called a real-time temperature difference. The real-time values T₁ and T₂ may be evaluated as single values (for example, single values at a given time t₀) or as averages of a plurality of temperature values, such as running averages calculated over a moving time period, as examples. As used herein, including the claims, an operating condition of media conditioner 110, its belt 120, or its roller 130 may refer to a condition when media is being processed or when the equipment is in a standby or waiting mode, with heating elements 142, 152 active but waiting to process a piece of media, as examples. Thus, in various examples, an operating condition may be a processing condition or a stand-by condition.

The threshold value, T_{tolerance}, may be a constant value as shown in this example:

T_{tolerance}=10 C 3

In other examples, the threshold value is a constant value selected from the range: 5 C to 15 C. In still other examples, the threshold value is a constant value less than 5 C or greater than 15 C. In some examples, the threshold value is within the range zero to 20 C. The threshold value, T_{tolerance}, may be determined based on limits of accuracy or on thermodynamic or heat transfer parameters related to belt 120, roller 130, heating lamps 140, 150, another component, or the media (e.g., thickness, material properties, etc.), as examples. The threshold value may be based on the feed rate of the media. Although units of degrees Celsius are shown, any unit for temperature may be used. In some examples, voltage, current, or resistance values from a temperature sensor are used without converting the data to a unit that is specifically associated with temperature.

The difference in temperatures for a reference operating condition, ΔT_{ref}, may be evaluated as:

ΔT_{ref}=(T_{1ref}−T_{2ref}) 4

In Expression 4, the parameter T_{1ref} is a temperature of the belt inner portion 123, and the parameter T_{2ref} is a temperature of the belt outer portion 124 for the reference condition. The first and second reference temperatures may be single values or may be averages of multiple data points collected during an earlier time period, for example. The reference temperature difference ΔT_{ref} of Expression 4 is based on a reference condition, which may be a design condition related to a specified heating rate of the heat lamps 140, 150, may be an operational period when the media conditioner 110 is known or perceived to be operating properly, or may be a desired condition or setting based on operational attributes (e.g., media size, density, or thickness or image size or density), as examples. The reference condition may be steady state, a heat-up ramp, or a cool-down ramp.

The evaluation of Expression 1 can also be written as:

|(T₁−T₂)−ΔT_{ref}|>T_{tolerance} 5

Expression 5 provides a true result when an absolute value taken after subtracting the reference temperature difference, ΔT_{ref}, from the real-time temperature difference, (T₁−T₂), is greater than the threshold value, T_{tolerance}. A true result from Expression 5 indicates a failing condition for media conditioner 110.

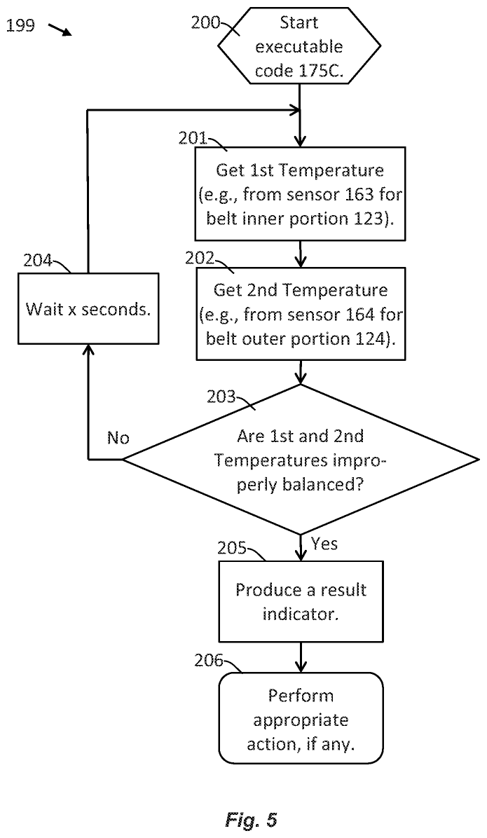

Referring to FIG. 5, an example process 199 of controller 170 evaluating the performance of temperature sensors 163, 164 is depicted. During operation, at block 200, controller 170 is to start executing machine executable code 175C. At block 201, the current value of the first temperature is to be retrieved or measured, and at block 202, the current value of the second temperature is to be retrieved or measured. At block 203, controller 170 is to perform a comparison between the first and second temperatures to determine whether they are improperly balanced or proportioned, as may be accomplished by selecting and evaluating Expressions 1, 3, and 4, for example. If the result of block 203 or Expression 1 is false (“No” in FIG. 5), then controller 170 determines that the measured temperatures read by sensors 163, 164 are acceptable, such as according to process 199, which is a passing condition, and operation of media conditioner 110 and printing system 100 continues. At block 204, controller 170 is to wait a predetermined length of time (e.g., x seconds or milliseconds), and then to begin the comparison again from block 201. If the result of block 203 or Expression 1 is true (“Yes”), then the temperatures provided to the first and second heating elements 142, 152 are determined to be improperly balanced, and controller 170 is to produce a result indicator at block 205. As a consequence, at block 206, controller 170 may perform an appropriate action, such as reducing the first and second power levels to zero or any of the other actions previously mentioned, as examples. In some examples, block 203 utilizes Expression 2 and the logic for process 199 is adjusted accordingly. In some examples, controller 170 continues to run process 199 and is to cease to produce the result indicator when a subsequent evaluation of Expression 1 returns a false value or Expression 2 returns a true value. In those examples, the operation of media conditioner 110 and system 100 may return to normal, assuming no other fault has occurred in system 100.

In some examples, controller 170 includes wired circuits that accomplish some aspects of the functionality described for codes 175A, 175B, 175C. Controller 170 may be implemented within a single housing or may be distributed in multiple housings or circuits through the extent of media conditioner 110 or printing system 100.

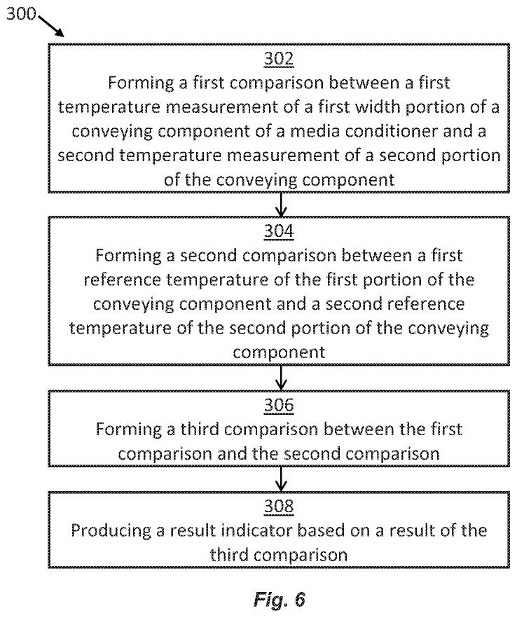

FIG. 6 presents an example of a method 300 for comparing the temperatures on portions of a conveying component in a media conditioner. A goal of method 300 is to confirm that a uniform temperature or a selected temperature distribution exists across the width of the conveying component. Block 302 of method 300 includes forming a first comparison between a first temperature measurement of a first width portion of a conveying component of a media conditioner and a second temperature measurement of a second portion of the conveying component. Block 304 includes forming a second comparison between a first reference temperature of the first portion of the conveying component and a second reference temperature of the second portion of the conveying component. Block 306 includes forming a third comparison between the first comparison and the second comparison. Block 308 includes producing a result indicator based on a result of the third comparison.

In an example, method 300 includes the use of Expression 1 (above). In this example, forming the first comparison of Block 302 includes determining a first temperature difference, e.g., (T₁−T₂), the real-time temperature difference between the first and second measured temperatures. Forming the second comparison of Block 302 includes determining a second temperature difference, which may be the reference temperature difference, ΔT_{ref}, evaluated from first and second reference temperatures, T_{1ref} and T_{2ref}, as shown in Expression 4, above. Forming the third comparison of Block 306 includes determining a third temperature difference between the first temperature difference and the second temperature difference. For example, in Expression 1, the third temperature difference is (T₁−T₂)−ΔT_{ref}. At Block 308, the result indicator is to be generated or produced when the third temperature difference of Block 306 is greater than the threshold value, e.g., T_{tolerance}, or less than the negative of the threshold value, which would be a “true” result from Expression 1, representing a failing condition for media conditioner 110. This outcome may also be described by stating that the result indicator is to be produced if the magnitude of the third temperature difference is greater than the magnitude of the threshold value. Thus, in this example, method 300 evaluates a comparison that includes the first temperature difference, the second temperature difference, and a threshold value and is to produce a result indicator based on the comparison. The method may further include ceasing to produce or negating the result indicator in response to the magnitude of the third difference becoming equal to or dropping below the magnitude of the threshold value in a subsequent time period.

The third comparison of Block 306 may also be evaluated using Expression 5, which also involves a first, a second, and a third temperature difference. Then, At Block 308, the result indicator may be generated or produced when the absolute value of a subtraction of the second temperature difference from the first temperature difference is greater than a threshold value.

In some examples, method 300 includes the use of Expression 2 to perform corresponding activities and to achieve the accomplishments described herein. Some implementations of method 300 may incorporate other functionalities disclosed herein. Various examples of method 300 may be implemented in media conditioner 110, and some examples, the functionality of method 300 is included in code 175C (FIG. 4).

The above discussion is meant to be illustrative of the principles and various examples of the present disclosure. Numerous variations and modifications will become apparent to those skilled in the art. It is intended that the following claims be interpreted to embrace all such variations and modifications.

What is claimed is:

1. A media conditioner comprising:
a heated conveying component to convey a sheet of printable media, the conveying component including a first portion extending widthwise, and a second portion extending widthwise from the first portion;
a first temperature sensor to measure temperature of the first portion of the conveying component;
a second temperature sensor to measure temperature of the second portion of the conveying component; and
a controller to produce a determination involving a first temperature at the first portion of the conveying component, a second temperature at the second portion of the conveying component, a reference temperature of the first portion, and a reference temperature of the second portion, and a threshold value,
wherein the controller is to produce a result indicator based on the comparison.

2. The media conditioner of claim 1 wherein the first temperature includes an average of a plurality of temperature measurements, and the second temperature includes an average of a plurality of temperature measurements,
wherein the determination is to include a first temperature difference that is a difference between the first temperature and the second temperature,
wherein the determination is to include a determination of a second temperature difference that is a difference between the reference temperatures of the first and second portions of the conveying component,
wherein the determination is to include a determination of a third temperature difference that is a difference between the first temperature difference and the second temperature difference, and
wherein the controller is to produce the result indicator when the third temperature difference is greater than the threshold value or less than the negative of the threshold value.

3. The media conditioner of claim 1 comprising:
a first heating element to heat the first portion of the conveying component; and
a second heating element to heat the second portion of the conveying component,
wherein the controller is to provide a first power level to the first heating element and a second power level to the second heating element to cause the first and second heating elements to generate heat.

4. The media conditioner of claim 3 wherein the media conditioner is to set the first power level or the second power level to zero in response to the result indicator.

5. The media conditioner of claim 1 wherein the controller is to transmit the result indicator external to the controller.

6. The media conditioner of claim 1 wherein the conveying component comprises a belt,
wherein the first and the second heating elements extend within the belt,
wherein the first heating element is to heat an inner portion of a width of the belt,
wherein the second heating element is to heat an outer portion of the width of the belt, including two sides of the belt separated by the inner portion, and
wherein the conveying component is to heat the sheet of printable media.

7. A media printing system comprising:
a print engine to form an image on a sheet of printable media; and
a media conditioner coupled to the print engine to process the sheet of printable media, the media conditioner comprising:
a heated conveying component including a first portion and a second portion to convey a sheet of printable media;
a first temperature sensor to measure temperature of the first portion of the conveying component; and
a second temperature sensor to measure temperature of the second portion of the conveying component; and
a controller to control the heating of the first and second portions of the conveying component,
wherein the controller is to determine a first temperature difference between a first temperature at the first portion of the conveying component and a second temperature at the second portion of the conveying component,
wherein the controller is to determine a second temperature difference between a reference temperature of the first portion of the conveying component and a reference temperature of the second portion of the conveying component, and
wherein the controller is to produce a determination involving the first temperature difference, the second temperature difference, and a threshold value and is to produce a result indicator based on the determination.

8. The media printing system of claim 7 wherein the controller is to determine a third temperature difference between the first temperature difference and the second temperature difference, and
wherein the controller is to produce the result indicator when the magnitude of the third temperature difference is greater than the magnitude of the threshold value.

9. The media printing system of claim 8 wherein the controller is to produce the result indicator in a first time period;
wherein in a subsequent time period, the controller is to determine updated values of the first, second, and third temperature differences; and
wherein the controller is to cease to produce the result indicator in response to the magnitude of the updated value of the third temperature difference being less than or equal to the magnitude of the threshold value.

10. The media printing system of claim 7 comprising:
a first heating element to heat a first portion of the conveying component; and
a second heating element to heat a second portion of the conveying component,
wherein the controller is to provide a first power level to the first heating element and a second power level to the second heating element, and
wherein the first temperature includes an average of a plurality of temperature measurements, and the second temperature includes an average of a different plurality of temperature measurements.

11. The media printing system of claim 10 wherein the media conditioner is to receive the sheet of printable media from the print engine,
wherein the conveying component comprises a belt,
wherein the first heating element is to heat an inner portion of a width of the belt,
wherein the second heating element is to heat an outer portion of the width of the belt,
wherein the media conditioner includes a driven roller coupled the belt to cause the belt to rotate, and
wherein a portion of the first heating element and a portion of the second heating element are disposed inside a path of the belt.

12. The media printing system of claim 7 wherein the media conditioner is to stop processing printable media in response to the result indicator.

13. A method comprising:
forming a first comparison between a first temperature in a first width portion of a media conditioner conveying component and a second temperature in a second width portion of the media conditioner conveying component;
forming a second comparison between a first reference temperature of the first width portion of the media conditioner conveying component and a second reference temperature of the second width portion of the media conditioner conveying component;
forming a third comparison between the first comparison and the second comparison; and
producing a result indicator based on a result of the third comparison.

14. The method of claim 13, wherein forming the first comparison includes determining a first temperature difference between the first and second temperatures,
wherein forming the second comparison includes determining a second temperature difference between the first and second reference temperatures,
wherein forming the third comparison includes determining a third temperature difference between the first temperature difference and the second temperature difference, and
wherein producing the result indicator is based on a result of the magnitude of the third temperature difference being greater than the magnitude of a threshold value.

15. The method of claim 13 wherein forming the first comparison includes determining a first temperature difference between the first and second temperatures,
wherein forming the second comparison includes determining a second temperature difference between the first and second reference temperatures, and
wherein producing the result indicator comprises producing the result indicator as a result of the absolute value of a subtraction of the second temperature difference from the first temperature difference being greater than a threshold value.
